(19) United States
(12) Patent Application Publication
(10) Pub. No.: US 2017/0332436 A1
(43) Pub. Date: Nov. 16, 2017

(54) Device and Method Handling a Radio Resource Control Connection Resume Procedure

(71) Applicant: HTC Corporation, Taoyuan City (TW)

(72) Inventor: Te-Ming Chen, Taoyuan City (TW)

(21) Appl. No.: 15/499,912

(22) Filed: Apr. 28, 2017

Related U.S. Application Data
(60) Provisional application No. 62/335,684, filed on May 13, 2016.

(51) Int. Cl. H04W 76/04; H04W 48/16

(52) U.S. Cl. CPC H04W 76/046; H04W 48/16

(57) ABSTRACT

A communication device for handling a radio resource control (RRC) connection resume procedure comprises a storage unit for storing instructions and a processing circuit coupled to the storage unit. The processing circuit is configured to execute the instructions stored in the storage unit. The instructions comprise a RRC layer of the communication device receiving a first RRC connection resume request from an evolved packet system (EPS) mobility management (EMM) layer of the communication device; the RRC layer performing an access barring check to detect whether an access to a serving cell of the communication device is barred; the RRC layer processing a resume user equipment (UE) context and a resumeIdentity according to the access barring check; and the RRC layer informing a status of the resume UE context and/or the resumeIdentity to the EMM layer according to the processing.

### CROSS REFERENCE TO RELATED APPLICATIONS

This application claims the benefit of U.S. Provisional Application No. 62/335,684 filed on May 13, 2016, which is incorporated herein by reference.

### BACKGROUND OF THE INVENTION

### 1. Field of the Invention

The present invention relates to a device and a method used in a wireless communication system, and more particularly, to a device and a method of handling a radio resource control connection resume procedure.

### 2. Description of the Prior Art

A long-term evolution (LTE) system provides high data rate, low latency, packet optimization, and improved system capacity and improved coverage. The LTE system is evolved continuously to increase peak data rate and throughput by using advanced techniques, such as carrier aggregation (CA), dual connectivity, licensed-assisted access, etc. In the LTE system, a radio access network known as an evolved universal terrestrial radio access network (E-UTRAN) includes at least one evolved Node-B (eNB) for communicating with at least one user equipment (UE), and for communicating with a core network. The core network may include a mobility management and a Quality of Service (QoS) control of the at least one UE.

If a radio resource control (RRC) connection resume fails (i.e., is not performed successfully), a RRC layer of a UE does not release a resume UE context and an evolved packet system (EPS) mobility management (EMM) layer of the UE may enter a wrong state. Accordingly, the EMM layer cannot request the RRC layer to resume the RRC connection, before it receiving another suspend indication. Thus, how to handle a RRC connection resume failure is an important problem to be solved.

### SUMMARY OF THE INVENTION

The present invention therefore provides a communication device and method for handling a RRC connection resume procedure selection to solve the abovementioned problem.

A communication device for handling a radio resource control (RRC) connection resume procedure comprises a storage unit for storing instructions and a processing circuit coupled to the storage unit. The processing circuit is configured to execute the instructions stored in the storage unit. The instructions comprise a RRC layer of the communication device receiving a first RRC connection resume request from an evolved packet system (EPS) mobility management (EMM) layer of the communication device; the RRC layer performing an access barring check to detect whether an access to a serving cell of the communication device is barred; the RRC layer processing a resume user equipment (UE) context and a resumeIdentity according to the access barring check; and the RRC layer informing a status of the resume UE context and/or the resumeIdentity to the EMM layer according to the processing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

### DETAILED DESCRIPTION

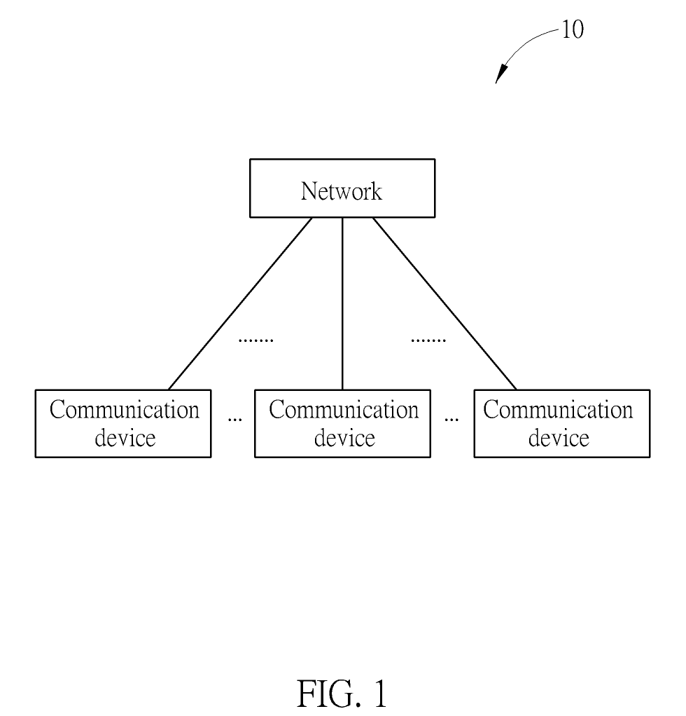

FIG. 1 is a schematic diagram of a wireless communication system 10 according to an example of the present invention. The wireless communication system 10 is briefly composed of a network and a plurality of communication devices. The network and a communication device may communicate with each other via one or more carriers of licensed band (s) and/or unlicensed band (s). The network and the communication device may simultaneously communicate with each other via multiple cells (e.g., multiple carriers) including a primary cell (PCell) and one or more secondary cells (SCells). The abovementioned cells may be operated in the same or different frame structure types, or in the same or different duplexing modes, i.e. frequency-division duplexing (FDD) and time-division duplexing (TDD). For example, the PCell may be operated on a licensed carrier, while the SCell may be operated on an unlicensed carrier.

In FIG. 1, the network and the communication devices are simply utilized for illustrating the structure of the wireless communication system 10. Practically, the network may be a narrowband (NB) internet of things (IoT) network or an evolved universal terrestrial radio access network (E-UTRAN) including at least one evolved Node-B (eNB). The network may be a fifth generation (5G) network including at least one 5G base station (BS) which employs orthogonal frequency-division multiplexing (OFDM) and/or non-OFDM and a transmission time interval (TTI) shorter than 1 ms (e.g. 100 or 200 microseconds), to communicate with the communication devices. In general, a BS may also be used to refer any of the eNB and the 5G BS.

Furthermore, the network may also include the GERAN/UTRAN/E-UTRAN and a core network, wherein the core network may include network entities such as Mobility Management Entity (MME), Serving Gateway (S-GW), Packet Data Network (PDN) Gateway (P-GW), Self-Organizing Networks (SON) server and/or Radio Network Controller (RNC), etc. The GERAN is an abbreviation of Global System for Mobile Communications (GSM) Enhanced Data rates for GSM Evolution (EDGE) Radio Access Network. In other words, after the network receives information transmitted by a communication device, the information may be processed only by the UTRAN/E-UTRAN and decisions corresponding to the information are made at the UTRAN/E-UTRAN. Alternatively, the UTRAN/E-UTRAN may forward the information to the core network, and the decisions corresponding to the information are made at the core network after the core network processes the information. In addition, the information may be processed by both the UTRAN/E-UTRAN and the core network, and the decisions are made after coordination and/or cooperation are performed by the UTRAN/E-UTRAN and the core network.

A communication device may be a user equipment (UE), a machine type communication (MTC) device, a mobile phone, a laptop, a tablet computer, an electronic book, a portable computer system, a vehicle, or an aircraft. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

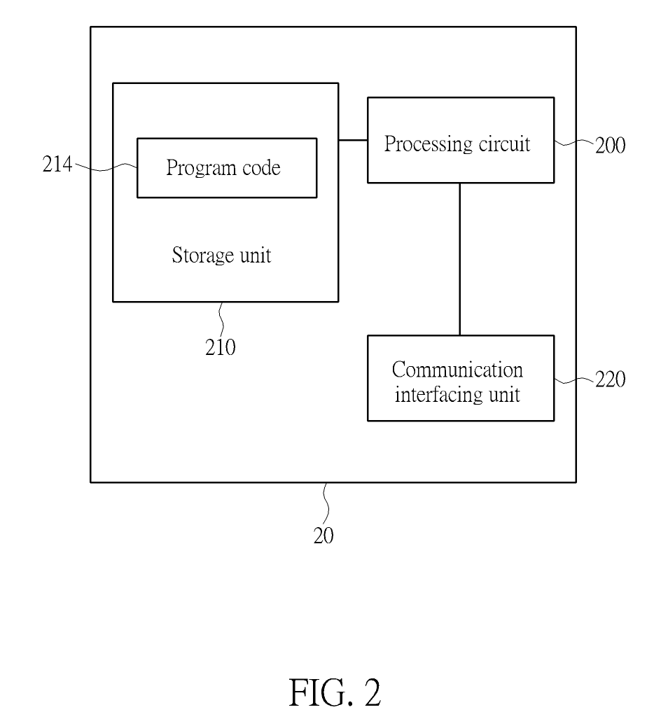

FIG. 2 is a schematic diagram of a communication device 20 according to an example of the present invention. The communication device 20 may be a communication device or the network shown in FIG. 1, but is not limited herein. The communication device 20 may include a processing circuit 200 such as a microprocessor or Application Specific Integrated Circuit (ASIC), a storage unit 210 and a communication interfacing unit 220. The storage unit 210 may be any data storage device that may store a program code 214, accessed and executed by the processing circuit 200. Examples of the storage unit 210 include but are not limited to a subscriber identity module (SIM), read-only memory (ROM), flash memory, random-access memory (RAM), hard disk, optical data storage device, non-volatile storage unit, non-transitory computer-readable medium (e.g., tangible media), etc. The communication interfacing unit 220 is preferably a transceiver and is used to transmit and receive signals (e.g., data, messages and/or packets) according to processing results of the processing circuit 200.

In the following embodiments, a UE is used for representing a communication device in FIG. 1, to simplify the illustration of the embodiments.

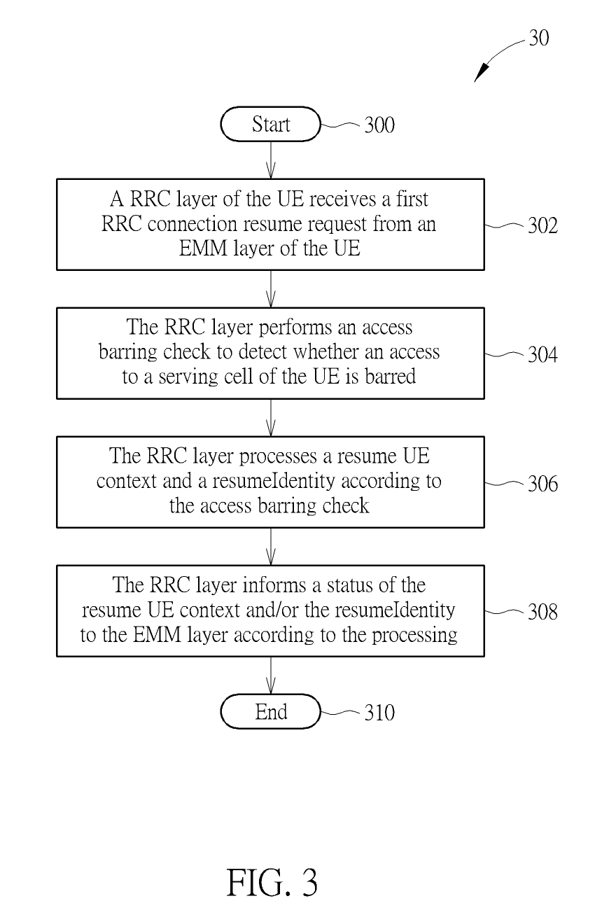

FIG. 3 is a flowchart of a process 30 according to an example of the present invention. The process 30 is utilized in a UE, to handle a radio resource control (RRC) connection resume procedure. The process 30 includes the following steps:

Step 300: Start.

Step 302: A RRC layer of the UE receives a first RRC connection resume request from an evolved packet system (EPS) mobility management (EMM) layer of the UE.

Step 304: The RRC layer performs an access barring check to detect whether an access to a serving cell of the UE is barred.

Step 306: The RRC layer processes a resume UE context and a resumeIdentity according to the access barring check.

Step 308: The RRC layer informs a status of the resume UE context and/or the resumeIdentity to the EMM layer according to the processing.

Step 310: End.

The RRC layer (i.e., UE RRC) in a RRC CONNECTED mode receives a RRC connection release message from a network. The RRC connection release message includes a resumeIdentity and a release cause, and the release cause is rrcSuspend. After receiving the RRC connection release message, the RRC layer stores the resumeIdentity and resume UE context and informs (e.g., by transmitting a RRC connection suspend indication) the EMM layer (i.e., UE EMM) that a RRC connection is suspended and the RRC enters a RRC_ILDE mode. After receiving the RRC connection suspend indication from the RRC layer, the EMM layer enters a EMM-IDLE with suspend indication. The EMM layer in the EMM-ILDE with suspend indication intends to transmit an initial NAS message to the network, and requests the RRC layer to perform a RRC connection resume procedure.

According to the process 30, a RRC layer of the UE receives a first RRC connection resume request from an EMM layer of the UE. Then, the RRC layer performs an access barring check to detect whether an access to a serving cell of the UE is barred. The RRC layer processes a resume UE context and a resumeIdentity according to the access barring check. The RRC layer informs a status of the resume UE context and/or the resumeIdentity to the EMM layer according to the processing. That is, the status of the resume UE context and/or the resumeIdentity is informed to the EMM layer (e.g., via a bit “0” or “1”), such that the EMM layer can perform correct operations according to the status of the resume UE context and/or the resumeIdentity, e.g., whether the resume UE context and/or the resumeIdentity is available. Thus, problem in the art regarding the RRC connection resume failure is solved.

Realization of the process 30 is not limited to the above description. An example of the channel access procedure is described as follows.

In one example, the RRC layer does not release the resume UE context and the resumeIdentity, after detecting that the access to the serving cell is barred. In addition, the RRC layer informs the EMM layer that a RRC connection resume failure occurs, informs the EMM layer that the access to the serving cell is barred, and informs the EMM layer that the resume UE context and/or the resumeIdentity is available. Further, the EMM layer may enter an EMM-IDLE with suspend indication.

In another example, the RRC layer transmits a second RRC connection resume request message to a network and starting a timer (e.g., T300), after detecting that the access to the serving cell is not barred. Five examples are described as follows to illustrate the cases that the serving cell is not barred.

In one example, the RRC layer does not release the resume UE context and the resumeIdentity, after the timer is expired. In addition, the RRC layer informs the EMM layer that a RRC connection resume fails, and informs the EMM layer that the resume UE context and/or the resumeIdentity is available. Further, the EMM layer may enter an EMM-IDLE with suspend indication.

In one example, the RRC layer releases the resume UE context and the resumeIdentity if a RRC connection reject message does not include rrc-SuspendIndication, after receiving the RRC connection reject message from the network and before the timer is expired. In addition, the RRC layer informs the EMM layer that a RRC connection resume fails, and informs the EMM layer that the resume UE context and/or the resumeIdentity is not available. Further, the EMM layer may enter an EMM-IDLE without suspend indication.

In one example, the RRC layer does not release the resume UE context and the resumeIdentity if a RRC connection reject message includes rrc-SuspendIndication, after receiving the RRC connection reject message from the network and before the timer is expired. In addition, the RRC layer informs the EMM layer that a RRC connection resume fails, and informs the EMM layer that the resume UE context and/or the resumeIdentity is available. Further, the EMM layer may enter an EMM-IDLE with suspend indication.

In one example, the RRC layer releases the resume UE context and the resumeIdentity, after receiving a RRC connection setup message from the network and before the timer is expired. In addition, the RRC layer informs the EMM layer that a RRC connection resume failure occurs and informs the EMM layer that the resume UE context and/or the resumeIdentity is not available, and/or informs the EMM layer that a RRC connection establishment successes. Further, the EMM layer may enter an EMM-CONNECTED.

In one example, the RRC layer release the resume UE context and the resumeIdentity, after receiving a RRC connection resume message from the network and before the timer is expired. In addition, the RRC layer informs the EMM layer that a RRC connection resume successes and informs the EMM layer that the resume UE context and/or the resumeIdentity is not available.

In one example, the RRC layer generates a RRC connection resume failure indication comprising a field, and transmits the RRC connection resume failure indication to the EMM layer. The field indicates the EMM layer to enter an EMM-IDLE with suspend indication, an EMM-IDLE without suspend indication or an EMM-CONNECTED.

In one example, the RRC layer generates a RRC connection resume failure indication comprising a first field and a second field, and transmits the RRC connection resume failure indication to the EMM layer. The first field indicates whether the resume UE context and the resumeIdentity are available, and the second field indicates whether a RRC connection establishment successes.

For example, the first field is set to “TRUE” for indicating that the resume UE context and the resumeIdentity are available, and is set to “FALSE” for indicating that the resume UE context and the resumeIdentity are not available. The second field is set to “TRUE” for indicating that the RRC connection establishment success, and is set to “FALSE” for indicating that the RRC connection establishment fails. For example, the RRC layer includes the first field in the RRC connection resume failure indication to indicate that the resume UE context and the resumeIdentity are available, and does not include the first field in the RRC connection resume failure indication to indicate that the resume UE context and the resumeIdentity are not available. The RRC layer includes the second field in the RRC connection resume failure indication to indicate that the RRC connection establishment success, and does not include the second field to indicate that the RRC connection establishment fails.

In one example, the RRC layer generates a RRC connection resume failure indication and an indication comprising a field, and transmits the RRC connection resume failure indication and the indication to the EMM layer. The field indicates the EMM layer to enter an EMM-IDLE with suspend indication, an EMM-IDLE without suspend indication or an EMM-CONNECTED.

In one example, the RRC layer generates a RRC connection resume failure indication and an indication comprising a first field and a second field, and transmits the RRC connection resume failure indication and the indication to the EMM layer. The first field indicates whether the resume UE context and the resumeIdentity are available, and the second field indicates whether a RRC connection establishment successes.

For example, the first field is set to “TRUE” for indicating that the resume UE context and the resumeIdentity are available, and is set to “FALSE” for indicating that the resume UE context and the resumeIdentity are not available. The second field is set to “TRUE” for indicating that the RRC connection establishment success, and is set to “FALSE” for indicating that the RRC connection establishment fails. For example, the RRC layer includes the first field in the RRC connection resume failure indication to indicate that the resume UE context and the resumeIdentity are available, and does not include the first field in the RRC connection resume failure indication to indicate that the resume UE context and the resumeIdentity are not available. The RRC layer includes the second field in the RRC connection resume failure indication to indicate that the RRC connection establishment success, and does not include the second field to indicate that the RRC connection establishment fails.

In one example, the RRC layer generates a RRC connection resume failure indication with a type corresponding to whether the resume UE context and the resumeIdentity are available, and transmits a RRC connection resume failure indication and the indication to the EMM layer.

For example, when the resume UE context and the resumeIdentity are available, the RRC layer transmits a RRC connection resume failure indication with type 1 to the EMM layer, e.g., RRC connection resume internal failure indication. When the resume UE context and the resumeIdentity are not available, the RRC layer transmits a RRC connection resume failure indication with type 2 to the EMM layer, e.g., RRC connection resume rejected by network failure indication. When a RRC connection setup is transmitted in response to a RRC connection resume request message, the RRC layer transmits a RRC connection resume failure indication with type 3 to the EMM layer, e.g., RRC connection resume failure and setup success indication.

In one example, the RRC layer transmits a first indication and a second indication to the EMM layer, after receiving a RRC connection setup message from the network in response to a RRC connection resume request message and before the timer is expired, wherein the first indication is a RRC connection resume failure indication and the second indication is a RRC connection establishment success indication.

In one example, the initial NAS message mentioned previously is an ATTACH REQUEST message, a DETACH REQUEST message, a TRACKING AREA UPDATE REQUEST message, a SERVICE REQUEST message or an EXTENDED SERVICE REQUEST message.

In one example, the EMM layer requests the RRC layer to release the resume UE context and resumeIdentity, after receiving a RRC connection resume failure indication from the RRC layer.

It should be noted that a situation where a RRC connection resume fails and a new RRC connection is established successfully may be turned as “fallback”. “RRC connection resume requests” transmitted from an EMM layer to a RRC layer and from the RRC layer to a network may be different. Thus, the term of “RRC connection resume request” is used for representing the transmission (or notification) from the EMM layer to the RRC layer, and the term of “RRC connection resume request message” is used for representing the transmission (or notification) from the RRC layer to the network.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20. Any of the above processes and examples above may be compiled into the program code 214.

To sum up, the present invention provides a method and a communication device for handling a RRC connection resume failure. A status of a resume UE context and/or a resumeIdentity is informed to an EMM layer, such that the EMM layer can perform correct operations according to the status of the resume UE context and/or the resumeIdentity. Thus, problem in the art regarding the RRC connection resume failure is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling a radio resource control (RRC) connection resume procedure, comprising:
a storage unit, for storing instructions of:
a RRC layer of the communication device receiving a first RRC connection resume request from an evolved packet system (EPS) mobility management (EMM) layer of the communication device;
the RRC layer performing an access barring check to detect whether an access to a serving cell of the communication device is barred;
the RRC layer processing a resume user equipment (UE) context and a resumeIdentity according to the access barring check; and
the RRC layer informing a status of the resume UE context and/or the resumeIdentity to the EMM layer according to the processing; and
a processing circuit, coupled to the storage unit, configured to execute the instructions stored in the storage unit.

2. The communication device of claim 1, wherein the storage unit further stores the instructions of:
the RRC layer not releasing the resume UE context and the resumeIdentity, after detecting that the access to the serving cell is barred; and
the RRC layer informing the EMM layer that a RRC connection resume failure occurs, informing the EMM layer that the access to the serving cell is barred, and informing the EMM layer that the resume UE context and/or the resumeIdentity is available.

3. The communication device of claim 2, wherein the storage unit further stores the instruction of:
the EMM layer entering an EMM-IDLE with suspend indication.

4. The communication device of claim 1, wherein the storage unit further stores the instruction of:
the RRC layer transmitting a second RRC connection resume request message to a network and starting a timer, after detecting that the access to the serving cell is not barred.

5. The communication device of claim 4, wherein the storage unit further stores the instructions of:
the RRC layer not releasing the resume UE context and the resumeIdentity, after the timer is expired; and
the RRC layer informing the EMM layer that a RRC connection resume fails, and informing the EMM layer that the resume UE context and/or the resumeIdentity is available.

6. The communication device of claim 5, wherein the storage unit further stores the instruction of:
the EMM layer entering an EMM-IDLE with suspend indication.

7. The communication device of claim 4, wherein the storage unit further stores the instructions of:
the RRC layer releasing the resume UE context and the resumeIdentity if a RRC connection reject message does not include rrc-SuspendIndication, after receiving the RRC connection reject message from the network and before the timer is expired; and
the RRC layer informing the EMM layer that a RRC connection resume fails, and informing the EMM layer that the resume UE context and/or the resumeIdentity is not available.

8. The communication device of claim 7, wherein the storage unit further stores the instruction of:
the EMM layer entering an EMM-IDLE without suspend indication.

9. The communication device of claim 4, wherein the storage unit further stores the instructions of:
the RRC layer not releasing the resume UE context and the resumeIdentity if a RRC connection reject message includes rrc-SuspendIndication, after receiving the RRC connection reject message from the network and before the timer is expired; and
the RRC layer informing the EMM layer that a RRC connection resume fails, and informing the EMM layer that the resume UE context and/or the resumeIdentity is available.

10. The communication device of claim 9, wherein the storage unit further stores the instruction of:
the EMM layer entering an EMM-IDLE with suspend indication.

11. The communication device of claim 4, wherein the storage unit further stores the instructions of:
the RRC layer releasing the resume UE context and the resumeIdentity, after receiving a RRC connection setup message from the network and before the timer is expired; and
the RRC layer informing the EMM layer that a RRC connection resume failure occurs and informing the EMM layer that the resume UE context and/or the resumeIdentity is not available, and/or informing the EMM layer that a RRC connection establishment successes.

12. The communication device of claim 11, wherein the storage unit further stores the instruction of:
the EMM layer entering an EMM-CONNECTED.

13. The communication device of claim 4, wherein the storage unit further stores the instructions of:
the RRC layer releasing the resume UE context and the resumeIdentity, after receiving a RRC connection resume message from the network and before the timer is expired; and
the RRC layer informing the EMM layer that a RRC connection resume successes and informing the EMM layer that the resume UE context and/or the resumeIdentity is not available.

14. The communication device of claim 1, wherein the storage unit further stores the instruction of:
the RRC layer generating a RRC connection resume failure indication comprising a field; and
the RRC layer transmitting the RRC connection resume failure indication to the EMM layer;
wherein the field indicates the EMM layer to enter an EMM-IDLE with suspend indication, an EMM-IDLE without suspend indication or an EMM-CONNECTED.

15. The communication device of claim 1, wherein the storage unit further stores the instruction of:
the RRC layer generating a RRC connection resume failure indication comprising a first field and a second field; and
the RRC layer transmitting the RRC connection resume failure indication to the EMM layer;
wherein the first field indicates whether the resume UE context and the resumeIdentity are available, and the second field indicates whether a RRC connection establishment successes.

16. The communication device of claim 1, wherein the storage unit further stores the instruction of:
the RRC layer generating a RRC connection resume failure indication and an indication comprising a field; and
the RRC layer transmitting the RRC connection resume failure indication and the indication to the EMM layer;
wherein the field indicates the EMM layer to enter an EMM-IDLE with suspend indication, an EMM-IDLE without suspend indication or an EMM-CONNECTED.

17. The communication device of claim 1, wherein the storage unit further stores the instruction of:
the RRC layer generating a RRC connection resume failure indication and an indication comprising a first field and a second field; and
the RRC layer transmitting the RRC connection resume failure indication and the indication to the EMM layer;
wherein the first field indicates whether the resume UE context and the resumeIdentity are available, and the second field indicates whether a RRC connection establishment successes.

18. The communication device of claim 1, wherein the storage unit further stores the instruction of:
the RRC layer generating a RRC connection resume failure indication with a type corresponding to whether the resume UE context and the resumeIdentity are available; and
the RRC layer transmitting a RRC connection resume failure indication and the indication to the EMM layer.

19. The communication device of claim 1, wherein the storage unit further stores the instruction of:
the RRC layer transmitting a first indication and a second indication to the EMM layer, after receiving a RRC connection setup message from the network in response to a RRC connection resume request message and before the timer is expired;
wherein the first indication is a RRC connection resume failure indication and the second indication is a RRC connection establishment success indication.

20. The communication device of claim 1, wherein the storage unit further stores the instruction of:
the EMM layer requesting the RRC layer to release the resume UE context and resumeIdentity, after receiving a RRC connection resume failure indication from the RRC layer.
